(19) United States
(12) Patent Application Publication
(10) Pub. No.: US 2009/0178501 A1
(43) Pub. Date: Jul. 16, 2009

(54) Rotating axle with anti-shaking function

(76) Inventors: Wang-Jui Lee, Sinjhuang City (TW); Chin Chung Huang, Sinjhuang City (TW); Kuo-Tung Liao, Sinjhuang City (TW); Kun-Yeh Lee, Sinjhuang City (TW); Shao-Chen Tien, Sinjhuang City (TW)

Correspondence Address: TROXELL LAW OFFICE PLLC;ONE SKYLINE PLACE, SUITE 1404, 5205 LEESBURG PIKE, FALLS CHURCH, VA, 22041, US

(21) Appl. No.: 12/003,957

(22) Filed: Jan. 3, 2008

(30) Foreign Application Priority Data
Apr. 14, 2007 (TW) 096206033

(51) Int. Cl. F16H 21/00

(52) U.S. Cl. 74/25

(57) ABSTRACT

The present invention discloses a rotating axle with anti-shaking function that comprises: a fixed part with a sleeve which is axially formed to have an axle hole; an inner collar disposed with at least a hollow clamping ring; an end seal plate axially formed to have a through hole whose circumference is disposed with a plurality of slightly protruded portions fittingly connected and fastened onto one end of the axle hole; a movable part extending axially to form an axle which is inserted through the through hole and encircled with the clamping ring.

### FIELD OF THE INVENTION

The present invention relates to a rotating axle, and more particularly to a rotating axle with anti-shaking and anti-leaking function.

### BACKGROUND OF THE INVENTION

Consumer electronics with flip covers, such as portable computer, electronic dictionary, portable audio/video player, flip mobile phone, generally have a main body on the bottom, which is pivotally connected with the cover body on the top, such that the cover body may swing open or close with respect to the main body. Consequently, the rotating axle is key to the quality of the products described above.

“BIDIRECTIONAL POSITIONING HINGE STRUCTURE” is disclosed in the ROC Patent No. 420321, for example. The fixed base of the patent is made of metal casting. To enhance its wear resistance, the fixed base is axially formed to form a connection hole, whose top end is connected to a H-shape-groove, such that a plurality of tube springs forming an end portion with their spacing is positioned inside the H-shape groove. Further, an axle of a hinge is inserted into the central axle hole formed by the plurality of tube springs to form a hinge structure. The connection of the fixed base and a plurality of the tube springs of the hinge indeed provide a means of securing a soft metal casting and hard friction tube spring.

However, one of the shortcomings is the leaking or spilling from the opening of the connection hole for the tube spring and bearing shaft, thereby bringing dirt and thus affecting the pivoting of the rotating axle. More importantly, the tube spring made by bending and twisting metal is not a perfect circular shape such that when the pivot axle of the hinge rotates in the opening of the tube spring, lateral shaking tends to occur. Consequently, wear between these two rotating counterparts will inevitable aggravate.

“HINGE DEVICE” published in the ROC Patent No. 420321 comprises a fixed base provided with a connection hole, a tube spring, a pivotal axle inserting through the tube spring and disposed in the connection hole of the fixed hole. The pivotal axle is encirclingly inserted with an end seal plate, which is disposed with a positioning block at its outer side and is formed to have a through hole whose diameter not larger than that of the pivotal axle at its center for the passing of the pivotal axle. The opening of the connection hole of the fixed base is disposed with a positioning slot for the positioning of the positioning block of the end seal plate of the pivotal axle. Consequently, with the end seal plate being inserted into the connection hole of the fixed plate, the lubricating oil can be prevented from leaking. Also, the circular through can provide an intimate fit for the passing of the pivotal axle, thereby preventing the pivotal axle from shaking during pivotal rotation. Although the invention described can provide the anti-leaking and anti-shaking functions, the positioning block for the circumferential rim of the end seal plate and the positioning slot correspondingly formed at the connection hole have to be matched, thereby enhancing the manufacturing precision required and the difficulty of assembly. Further, the end seal plate is secured onto the connection hole of the fixed base only by inserting. If the tightness is not good enough, the anti-shaking function will be lost. Consequently, further improvement is required to securingly fix the end seal plate onto the opening of the connection hole.

### SUMMARY OF THE INVENTION

In view of the foregoing shortcomings of the prior art, the inventor of the present invention based on years of experience in the related industry to conduct extensive researches and experiments, and finally invented a rotating axle with anti-shaking function in accordance with the present invention.

The primary objective of the present invention is to provide a rotating axle with anti-shaking function that comprises: a fixed part with a sleeve which is axially formed to have an axle hole; an inner collar disposed with at least a hollow clamping ring; an end seal plate axially formed to have a through hole whose circumference is disposed with a plurality of slightly protruded portions fittingly connected and fastened onto one end of the axle hole; a movable part extending axially to form an axle which is inserted through the through hole and encircled with the clamping ring.

Another objective of the present invention is to provide a rotating axle with anti-shaking function, wherein the axle hole extends radially to form an embedding slot which is laterally formed to have at least an engagement slot; the clamping ring extends radially from its one end to form a frame strip and forms an opening with the frame strip, and the surface of the frame strip is protrudingly disposed with an engagement tenon corresponding to the engagement slot to fittingly connect the clamping ring, the frame strip, and the engagement tenon with the axle hole, embedding slot, and the engagement slot, respectively.

A further objective of the present invention is to provide a rotating axle with anti-shaking function, wherein the fixed part is further disposed with a connecting portion and the movable part is further disposed with a linking portion, and the connecting portion and the linking portion are disposed with at least a connection hole, respectively, or are formed as milled cylinders or polyhedral prisms.

Another further objective of the present invention is to provide a rotating axle with anti-shaking function, further comprising a second end seal plate which is fittingly connected and fastened onto the other end of the axle hole and the axial through hole is inserted through by the axle.

A further objective of the present invention is to provide a rotating axle with anti-shaking function, wherein the protruded portion of the end seal plate is disposed with embossing.

A further objective of the present invention is to provide a rotating axle with anti-shaking function, wherein the frame strip is formed at its surface to have at least a tenon slot/hole, and a fixture is aimed at the surface of the fixed part corresponding to the tenon slots/holes to stamp to form at least a concave portion at the surface of the fixed part and the materials deformed totally occupy the tenon slots/holes to form a cylindrical/bar-like protruding tenon.

### BRIEF DESCRIPTION OF THE DRAWINGS

FIG. 1 is an exploded view of a rotating axle in accordance with the first embodiment of the present invention;

FIG. 2 is a sectional assembly view of FIG. 1;

FIG. 3 is a perspective assembly view of FIG. 1;

FIG. 4 is an exploded view of a rotating axle in accordance with the second embodiment of the present invention;

FIG. 5 is a sectional assembly view of FIG. 4;

FIG. 6 is a perspective assembly view of FIG. 4.

### DETAILED DESCRIPTION OF THE PREFERRED EMBODIMENTS

The structure, technical measures and effects of the present invention will now be described in more detail hereinafter with reference to the accompanying drawings that show various embodiments of the invention.

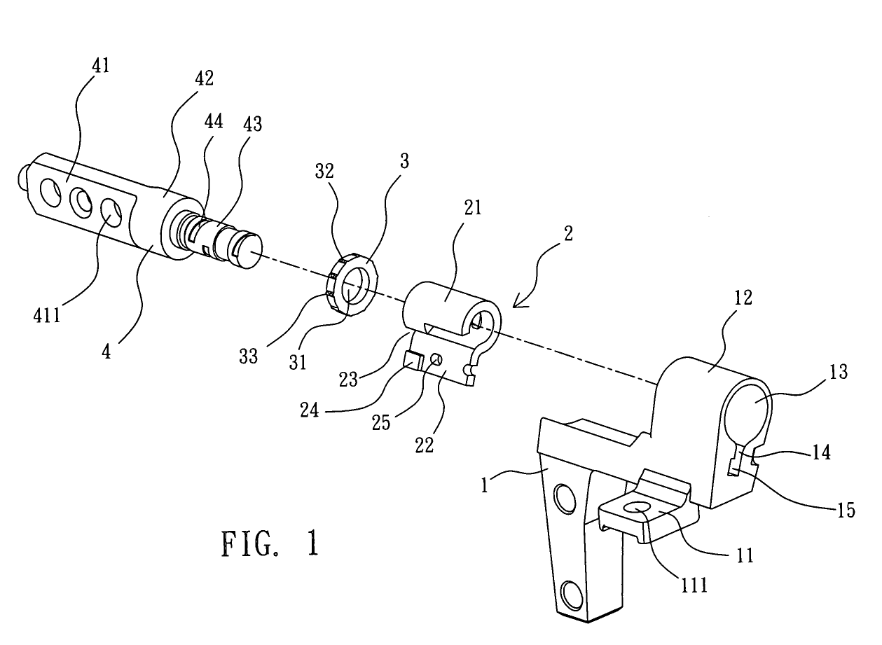

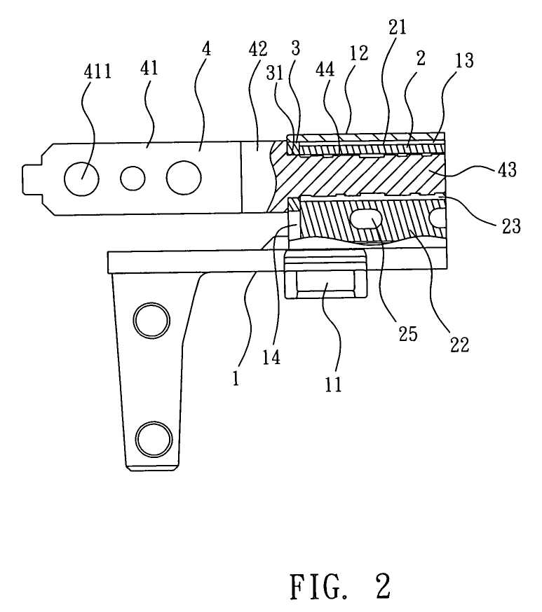

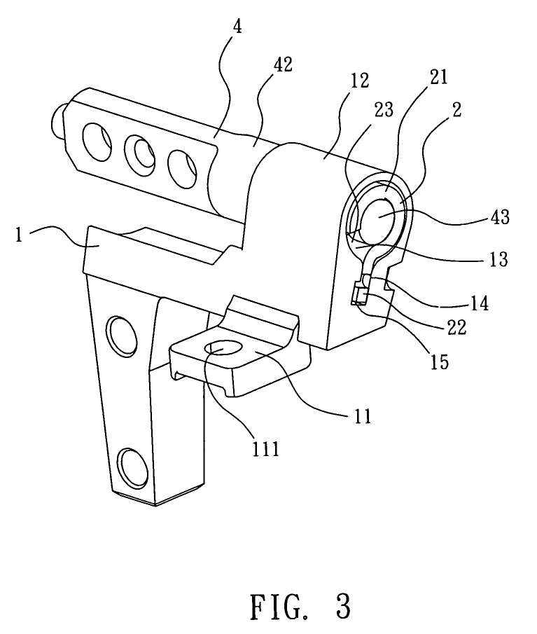

With reference to FIGS. 1 to 3, a rotating axle of the present invention comprises a fixed member 1, an inner collar 2, an end seal plate 3, and a movable member 4, wherein “fixed” and “movable” do not limit the movement status of the fixed member 1 and the movable member 4; when the present invention being implemented, the movable member 4 can maintain a fixed status, and the fixed member 1 can rotate.

The fixed member 1 is a base seat of soft metal, zinc for example, formed by die casting, with at least a connecting portion 11 for connecting onto an object, the main body of a notebook computer for example. With reference to the figures, the connecting portion 11 is disposed with at least a connection hole 111 for the insertion of conventional fastening elements, screws for example, to be fastened onto an object. The connecting portion 11, not limited to that described above, may also a milled cylinder or a polyhedral prism, a triangular prism, a quadratic prism, and so on for example, to be embeddly inserted and positioned in an object.

The connecting portion 11 extends from its one side to form a sleeve 12 which is axially formed to have an axle hole 13. The axle hole 13 along radial direction is communicatingly connected with an embedding slot 14 whose bottom end is horizontally formed to have an engagement slot 15 inter-communicated therebetween.

The inner collar 2 is a bended frame having at least a hollow clamping ring 21 which extends radially from its one end (the fixed end) to form a frame strip 22 and forms an opening 23 from the other end (movable end) and the frame strip 22, such that the clamping ring 21 has the capability of resilient extension and retraction. When the inner collar 2 is to be connected with the fixed member 1, the clamping ring 21 and the frame strip 22 of the inner collar 2 are aimed at and inserted into the axle hole 13 and the embedding slot 14, respectively.

The frame strip 22 is stamped at its surface to form at least an engagement tenon 24 connected onto the engagement slot 15 laterally communicating with the embedding slot 14 such that the inner collar 2 will not move laterally as a result of the rotation of the movable member 4. Further, to render the inner collar 2 securingly fastened inside the fixed member 1, the frame strip 22 is formed at its surface to have at least a tenon slot/hole 25, as shown in the figures, which is formed at the lower end of the clamping ring 21. After the inner collar 2 is embeddedly inserted the sleeve 12 of the fixed member 1, a fixture is then aimed at the surface of the fixed member 1 corresponding to the tenon slots/holes 25 to stamp to form a concave portion (not shown due to view angle) at the surface of the fixed member 1. The materials deformed can totally occupy the tenon slots/holes 25 to form a cylindrical/bar-like protruding tenon such that a securing position can be obtained between the inner collar 2 and the fixed member 1 without the concern of external axial forces fracturing the fixed member 1 and the inner collar 2.

The end seal plate 3 is a ring body axially formed to have a through hole 31 whose diameter corresponds to the external diameter of the axial bar 43. To enable the end seal plate 3 securingly fastened onto the opening end of the axle hole 13, the circumference of the end seal plate 3 is formed to have a plurality of slightly protruded portions 32, as shown in the figures, such that the end seal plate 3 is firmly connected onto and encircled with the axle hole 13. The surfaces of the protruded portions 32 are formed to have embossing 33 such that when the end seal plate 3 is insertingly fitted into the axle hole 13 by close fit, the embossing 33 of the protruded portions 32 can interference with the axle hole 13 and be secured therein.

The movable member 4 is an axle body with a linking portion 41 at its one end connected with an object, a frame for example, to be connected with the cover body of a notebook computer. As shown in the figures, the linking portion 41 is formed to have at least a connection hole 411 when implemented, such that conventional fastening parts, rivets for example, are inserted through the pre-formed frame holes and the connection holes 411 to connect the frame and the movable member 4 together into an integrated body. However, the linking portion 41, not limited to that described above, may also a milled cylinder or a polyhedral prism, a triangular prism, a quadratic prism, and so on for example, to be embeddly inserted and positioned in an object.

The movable member 4 at its roughly middle section is disposed with an axle ring 42 extending axially to form a axle 43 whose surface is disposed with a curved oil channel 44 to accommodate lubricating oil and to provide lubrication.

When the present invention being assembled, the clamping ring 21, frame strip 22, and the engagement tenon 24 of the inner collar 2 are first aimed at and inserted into the axle hole 13, embedding slot 14, and the engagement slot 15, respectively, in a close fit. Then the end seal plate 3 is inserted into the opening end of the axle hole 13, and the embossing 33 of the plurality of protruded portions 32 disposed at the circumference of the end seal plate 3 are clenched with the inner wall of the axle hole 13 to be securingly fastened therein. Further, a fixture is aimed at the tenon slots/holes 25 of the frame strip 22 in the fixed member 1 to conduct stamping process and to deform the surface into a concave portion. The deformed materials forming a protruding tenon to totally occupy the tenon slots/holes 25. Finally, the axle 43 of the movable member 4 is passed into the through hole 31 of the end seal plate 3 to be embeddly inserted into the clamping ring 21, such that the fixed member 1, inner collar 2, and the movable member 4 are securingly fastened together to complete the assembly of the present invention, and the end seal plate 3 provides the anti-shaking and anti-leaking functions.

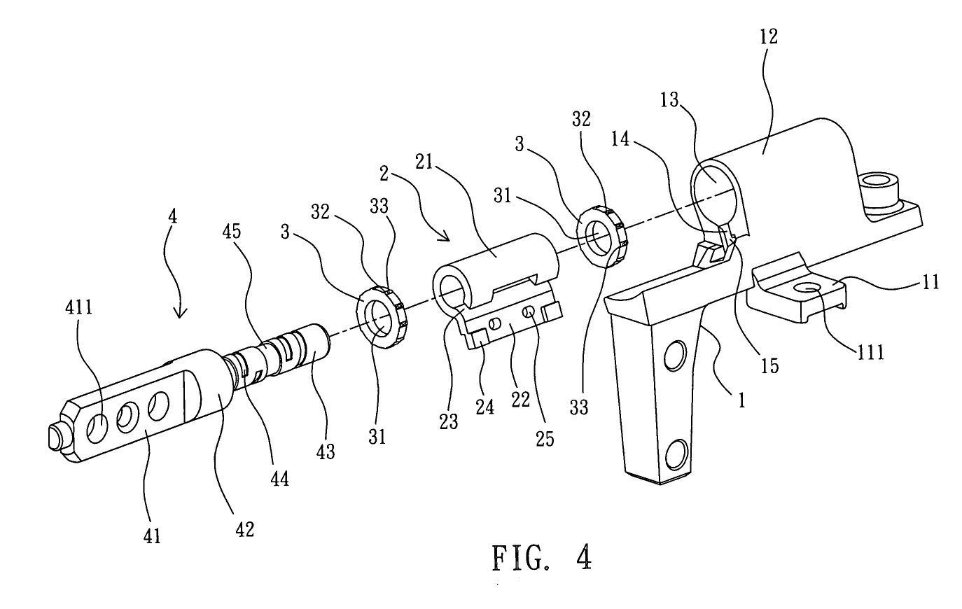

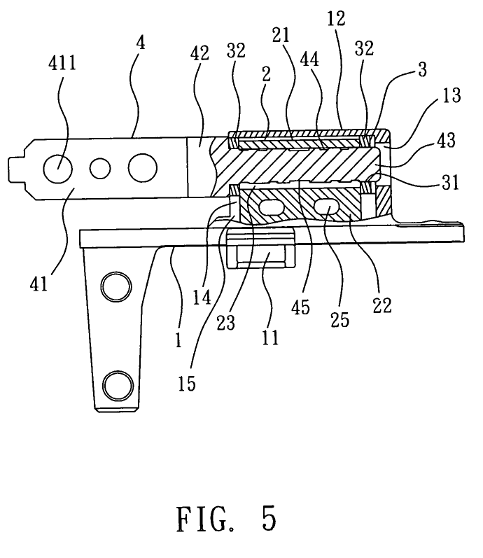

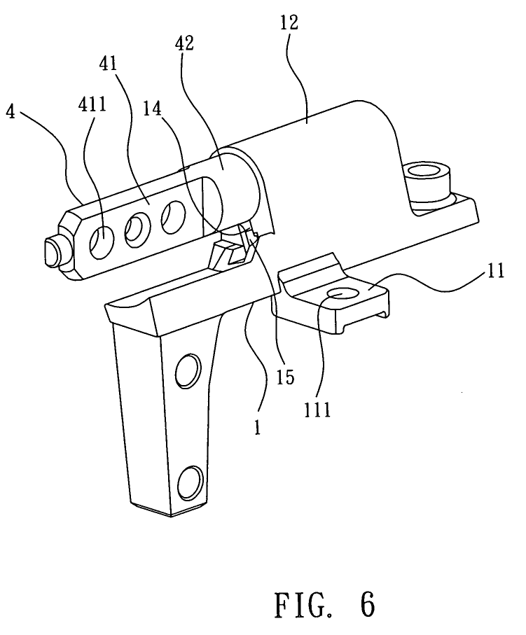

FIGS. 4 to 6 disclose the second embodiment, which differs the first embodiment in that both ends of the axle hole 13 of the sleeve 12 of the fixed member 1 are disposed with a end seal plate 3, respectively, and the axle 43 of the movable member 4 at its section is formed to have a concave slot 45, whose both sides form a frictional section, respectively. The advantage of the second embodiment is that both ends of the axle 43 are insertingly connected with an end seal plate 3 and thus the anti-shaking and anti-leaking functions can be enhanced.

With the implementation of the present invention, since at least an end seal plate is encircled and fastened in the axle hole of the fixed part, there is no directional restriction during assembly. Also, the embossing disposed at the surfaces of the plurality of slightly protruded portions can render the end seal plates securingly fastened onto one end of the axle hole. Consequently, when the end seal plates are passed through by the axle, the anti-shaking, anti-leaking, and securingly positioning advantages can be obtained. The present invention can thus overcome the shortcomings of conventional art and is indeed a breakthrough of its kind.

The present invention provides a feasible solution, and a patent application is duly filed accordingly. However, it is to be noted that the preferred embodiments disclosed in the specification and the accompanying drawings are not intended to limit the invention. To the contrary, it is intended to cover various modifications and similar arrangements and procedures, and thus the scope of the appended claims should be accorded the broadest interpretation so as to encompass all such modifications and similar arrangements and procedures.

What is claimed is:

1. A rotating axle with anti-shaking function comprising:
a fixed part with a sleeve which is axially formed to have an axle hole;
an inner collar disposed with at least a hollow clamping ring;
an end seal plate axially formed to have a through hole whose circumference is disposed with a plurality of slightly protruded portions fittingly connected and fastened onto one end of the axle hole; and
a movable part extending axially to form an axle which is inserted through the through hole and encircled with the clamping ring.

2. The rotating axle with anti-shaking function of claim 1, wherein the axle hole extends radially to form an embedding slot which is laterally formed to have at least an engagement slot; the clamping ring extends radially from its one end to form a frame strip and forms an opening with the frame strip, and the surface of the frame strip is protrudingly disposed with an engagement tenon corresponding to the engagement slot to fittingly connect the clamping ring, the frame strip, and the engagement tenon with the axle hole, embedding slot, and the engagement slot, respectively.

3. The rotating axle with anti-shaking function of claim 1, wherein the fixed part is further disposed with a connecting portion and the movable part is further disposed with a linking portion, and the connecting portion and the linking portion are disposed with at least a connection hole, respectively, or are formed as milled cylinders or polyhedral prisms.

4. The rotating axle with anti-shaking function of claim 1, further comprising a second end seal plate which is fittingly connected and fastened onto the other end of the axle hole and the axial through hole is inserted through by the axle.

5. The rotating axle with anti-shaking function of claim 1, wherein the protruded portion of the end seal plate is disposed with embossing

6. The rotating axle with anti-shaking function of claim 4, wherein the protruded portion of the end seal plate is disposed with embossing

7. The rotating axle with anti-shaking function of claim 1, wherein the surface of the axle is disposed with a curved oil channel.

8. The rotating axle with anti-shaking function of claim 1, wherein the frame strip is formed at its surface to have at least a tenon slot/hole, and a fixture is aimed at the surface of the fixed part corresponding to the tenon slots/holes to stamp to form at least a concave portion at the surface of the fixed part and the materials deformed totally occupy the tenon slots/holes to form a cylindrical/bar-like protruding tenon.
